(19) United States
(12) Patent Application Publication
(10) Pub. No.: US 2007/0047734 A1
(43) Pub. Date: Mar. 1, 2007

(54) Inmate telephone absent an inmate-accessible hook switch button

(75) Inventor: Harlie D. Frost, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/212,495

(22) Filed: Aug. 26, 2005

(51) Int. Cl. H04M 1/00; H04M 9/00

(52) U.S. Cl. 379/422

(57) ABSTRACT

An inmate telephone for use by inmates of a prison or a mental institution is disclosed and does not include an inmate-accessible hook switch. Inmates are issued inmate devices for inmate identification purposes and for inmate telephone use. The inmate telephone can include a device reader and when an inmate device is located in close proximity to the device reader, the inmate telephone may be activated to allow an inmate to make and receive telephone calls.

### FIELD OF THE DISCLOSURE

The present disclosure is generally related to telephone systems for use by inmates of a prison or a mental institution.

### BACKGROUND

Prison pay telephones are designed to mitigate a potential for inmates to physically harm themselves or others with their use. Some prison pay telephones are absent any inmate-accessible cords, such as a cord that would couple a handset to a body of the phone or a cord that would couple the phone to a telephone network. This prevents inmates from hanging themselves either directly on a cord or on clothes hung on the cord, and from pulling an element of the phone off the cord to use as a weapon.

To eliminate inmate-accessible cords, a prison pay telephone can be mounted to a wall, and can have its earpiece and mouthpiece mounted to a face of the telephone. Since this type of prison pay telephone has no handset to hang up, an on/off hook switch button is provided. The earpiece, the mouthpiece and the on/off hook switch button barely extend from the face of the telephone. U.S. Pat. No. 6,512,828 to Styron discloses an example of such a prison pay telephone.

### BRIEF DESCRIPTION OF THE DRAWINGS

FIG. 1 is a block diagram of an embodiment of a prison telephone system;

FIG. 2 is a flow chart of an embodiment of a method of operating a prison telephone system;

FIG. 3 is a block diagram that is representative of a general computer system.

### DETAILED DESCRIPTION OF THE DRAWINGS

The on/off hook switch button of existing prison pay telephones potentially may be used as a means for suicide or as a weapon. To address this problem, embodiments of an inmate pay telephone absent an inmate-accessible hook switch button or another type of inmate-accessible on/off button are disclosed herein.

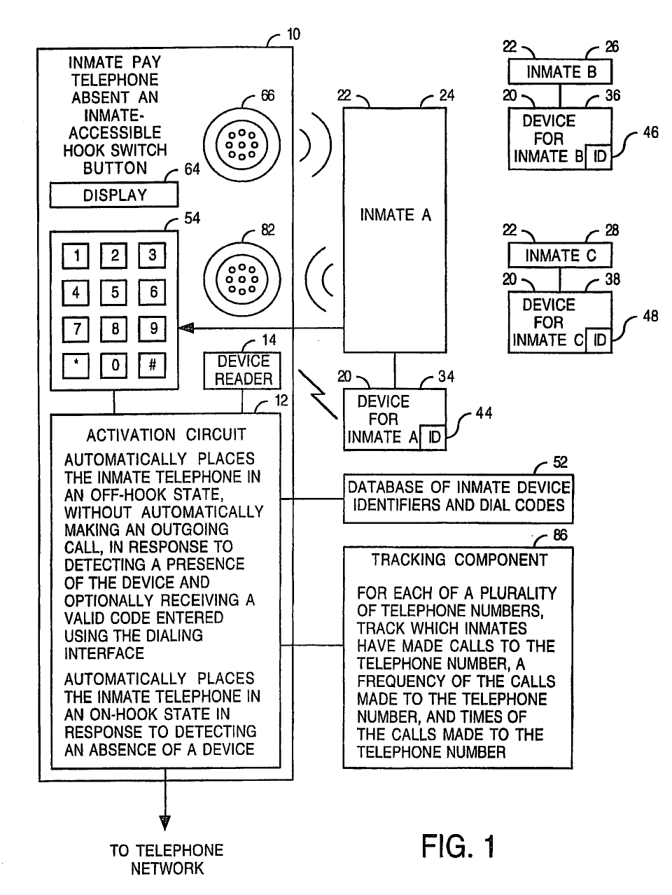

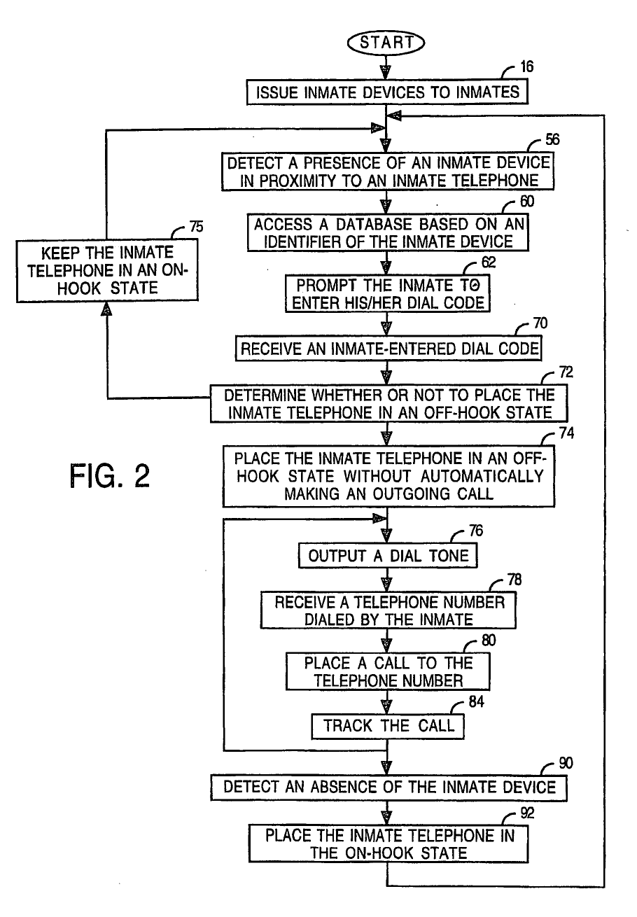

Embodiments are described with reference to FIG. 1, which is a block diagram of an embodiment of a prison telephone system, and FIG. 2, which is a flow chart of an embodiment of a method of operating the prison telephone system. Although described herein as a prison telephone system for use by inmates of a prison, the system can be used by inmates of a mental institution or individuals in other user-restricted environments where strong needs exist for safety and for monitoring telephone usage.

The system comprises an inmate telephone 10 that is absent an inmate-accessible hook-switch button or another type of inmate-accessible on/off button. Instead of using an inmate-accessible hook-switch button, the inmate telephone 10 comprises an activation circuit 12 responsive to a device reader 14 to automatically place the inmate telephone 10 in either an on-hook state or an off-hook state. Initially, the inmate telephone 10 is considered to be in an on-hook state.

As an alternative to the herein-disclosed on-hook and off-hook states, the activation circuit 12 can place the inmate telephone 10 in inactive and active states, respectively, in the manner disclosed herein. In the active state, the inmate telephone 10 enables an inmate to make an outgoing call. In the inactive state, the inmate telephone 10 inhibits the inmate from making an outgoing call. In this alternative case, the inmate telephone 10 is initially considered to be in an inactive state.

As indicated by block 16, the method comprises issuing inmate devices 20 to inmates 22 of a prison or a mental institution. For purposes of illustration and example, consider three inmates 24, 26 and 28 of the prison or the mental institution. Each of the inmates 24, 26 and 28 is issued a respective inmate device 34, 36 or 38 to carry on his/her person in the prison or the mental institution.

The inmate devices 20 may be issued to the inmates 22 specifically for inmate telephone use. Alternatively, the inmate devices 20 may be issued to the inmates 22 for inmate identification purposes and for inmate telephone use.

Each of the inmate devices 20 has an identifier that is readable by the device reader 14 when in close proximity to the device reader 14. For example, the inmate device 34 has an identifier 44, the inmate device 36 has an identifier 46 and the inmate device 38 has an identifier 48. The identifiers 44, 46 and 48 may uniquely identify the inmates 24, 26 and 28, respectively, and/or the inmate devices 34, 36, and 38, respectively.

Alternatively, the identifiers 44, 46 and 48 may identify allowable kinds of telephone use by the inmates 24, 26 and 28, respectively. In this case, two or more of the identifiers 44, 46, and 48 may be the same to identify the same allowable kind of telephone use. For example, the identifiers 44 and 46 may identify that the inmates 24 and 26 are permitted to make outgoing calls at any time of day, but the identifier 48 may identify that the inmate 28 is permitted to make outgoing calls only from 9:00 AM to 5:00 PM.

The identifiers 44, 46, and 48 can be stored as computer-readable data in a database 52. The database 52 can store data associated with each identifier 44, 46 and 48 to indicate allowable kinds of telephone use using the inmate device 34, 36 and 38, respectively. Further, the database 52 can store a respective dial code associated with each identifier 44, 46, and 48. Each inmate having an associated dial code must enter the dial code using a dialing interface 54 before he/she can make an outgoing call. The dialing interface 54 may comprise a key pad having digits of “0” to “9”, a star key “*”, and a pound key “#”.

The inmate devices 20 may have a variety of forms. In some embodiments, each of the inmate devices 20 may comprise a radio frequency identification (RFID) tag, in which case the device reader 14 comprises an RFID tag reader. Alternatively, each of the inmate devices 20 may comprise a substrate with an optical code, in which case the device reader 14 comprises an optical code reader. If the optical code is bar code, the device reader 14 comprises a bar code reader.

In some embodiments, the device reader 14 can detect and/or read an inmate device without contacting the inmate device. In other embodiments, the device reader 14 may contact an inmate device to detect and/or read the inmate device.

The inmate devices 20 may be either passive devices or active devices. Preferably, the inmate devices 20 are not used to power the inmate telephone 10. For example, if an inmate device comprises a battery, the battery is not used to power the inmate telephone 10.

As indicated by block 56, the method comprises detecting a presence of an inmate device in proximity to the inmate telephone 10. The presence of any of the inmate devices 20 in proximity to the inmate telephone 10 is detected by the device reader 14. For example, as depicted in FIG. 1, consider the inmate device 34 being in close proximity to the inmate telephone 10 and the device reader 14, but the inmate devices 36 and 38 being distantly located from the inmate telephone 10 and the device reader 14. In this scenario, the device reader 14 detects a presence of the inmate device 34, but does not detect a presence of the inmate devices 36 and 38. The device reader 14 reads the identifier 44 from the inmate device 34 proximate thereto, but does not read the identifiers 46 and 48.

As indicated by block 60, the method comprises accessing the database 52 based on the identifier 44 of the proximate inmate device 34. The database 52 is accessed to determine if the inmate device 34 is valid, if making an outgoing call is allowable for the inmate device 34 at the current time and day, and if the inmate 24 must enter a dial code.

As indicated by block 62, the method optionally comprises the activation circuit 12 prompting the inmate 24 to enter his/her dial code. The prompt can be in the form of a visual message displayed on a visual display 64, or an audible message outputted to an earpiece 66 or another audio output device.

As indicated by block 70, the method optionally comprises receiving an inmate-entered dial code. The inmate-entered dial code comprises a sequence of digits (e.g. four digits) entered using the dialing interface 54 and received by the activation circuit 12.

As indicated by block 72, the method comprises determining whether or not to place the inmate telephone 10 in an off-hook state for the inmate 24. The determination is made by the activation circuit 12 based on whether or not the inmate device 34 is valid, whether or not making an outgoing call is allowable for the inmate device 34 at the current time and day, and optionally whether or not the inmate-entered dial code is correct.

As indicated by block 74, the activation circuit 12 automatically places the inmate telephone 10 in the off-hook state based on the presence of the inmate device 34 being detecting, the inmate device 34 being valid and permitting an outgoing call at the current time and day, and optionally receiving the correct dial code from the inmate 24. Otherwise, the activation circuit 12 maintains the inmate telephone 10 in the on-hook state, as indicated by block 75. From block 75, flow of the method is directed back to block 56 to enable another inmate device to be processed.

Referring again to block 74, the activation circuit 12 places the inmate telephone 10 in the off-hook state without automatically making an outgoing call in the off-hook state. For example, the inmate telephone 10 is placed in the off-hook state without automatically dialing a telephone number based on the inmate device 34. Preferably, the inmate devices 34, 36 and 38 store no telephone number data, and/or no telephone number data is readable by the device reader 14 from the inmate devices 34, 36 and 38.

As indicated by block 76, a dial tone is outputted by the earpiece 66 or other audio output device to indicate that the inmate telephone 10 is in the off-hook state. When in the off-hook state, the inmate telephone 10 provides the inmate 24 access to a telephone network. Examples of the telephone network include, but are not limited to, a public switched telephone network, a Voice over Internet Protocol (VoIP) telephone network, a private branch exchange (PBX), and a virtual private network (VPN).

As indicated by block 78, the method comprises receiving a telephone number dialed by the inmate 24 using the inmate telephone 10 when the inmate telephone 10 is in the off-hook state. The inmate 24 dials the telephone number using the dialing interface 54.

As indicated by block 80, the method comprises placing a call to the telephone number. The call is routed via the telephone network to a called party at the telephone number. During the call, the inmate 24 communicates with the called party using the earpiece 66 and a mouthpiece 82.

As indicated by block 84, the method comprises tracking calls made using the inmate telephone 10. The calls are tracked by a tracking component 86. The tracking component 86 may be integrated with the inmate telephone 10 or may be external to the inmate telephone 10. For each of a plurality of different telephone numbers, the tracking component 86 tracks which of the inmates 22 have made calls to the telephone number, a frequency of calls made to the telephone number, and times of calls made to the telephone number. For each inmate, the tracking component 86 stores information about the calls made by the inmate.

Once the call ends, flow of the method can be directed back to block 76 to output the dial tone again. In this way, the system may enable the inmate 24 can to dial another telephone number to place another call.

As indicated by block 90, the method comprises detecting an absence of the inmate device 34 relative to a location of the inmate telephone 10. The inmate device 34 is considered absent when it is no longer in close proximity to the inmate telephone 10. The absence of the inmate device 34 can occur when the inmate 24 has walked away from the inmate telephone 10, for example, which may occur either before or after the call has ended. The device reader 14 is capable of detecting an absence of any of the inmate devices 20 relative to the inmate telephone 10, e.g. when all of the inmate devices 20 are distantly located from the inmate telephone 10.

As indicated by block 92, the method comprises the activation circuit 12 automatically placing the inmate telephone 10 in an on-hook state in response to the device reader 14 detecting the absence of the inmate device 34. When in the on-hook state, the inmate telephone 10 inhibits any inmate without his/her inmate device from placing an outgoing call. The inmate telephone 10 remains in the on-hook state (and provides no dial tone) until another inmate device is processed (as indicated by flow of the method being directed from block 92 back to block 56).

The inmate telephone 10 may be based on any of the telephones described in U.S. Pat. No. 6,512,828 to Styron and U.S. Patent Application Publication No. 2003/0112968 A1 to Styron, both of which are hereby incorporated by reference into this disclosure. In particular, the telephones disclosed in the aforementioned references can be adapted to replace their on-off push button switch with the device reader 14 and activation circuit 12 to produce embodiments of the inmate telephone 10. The inmate telephone 10 may be permanently mounted to a wall or another mounting surface of a prison or a mental institution without an inmate-accessible cord. Further, the earpiece 66 and the mouthpiece 82 may be mounted to a front face of the inmate telephone 10 without an inmate-accessible cord.

The herein-disclosed acts performed by the activation circuit 12 and/or the device reader 14 may be directed by one or more computer processors. The computer processor(s) may perform acts based on computer-readable program code stored by a computer-readable medium.

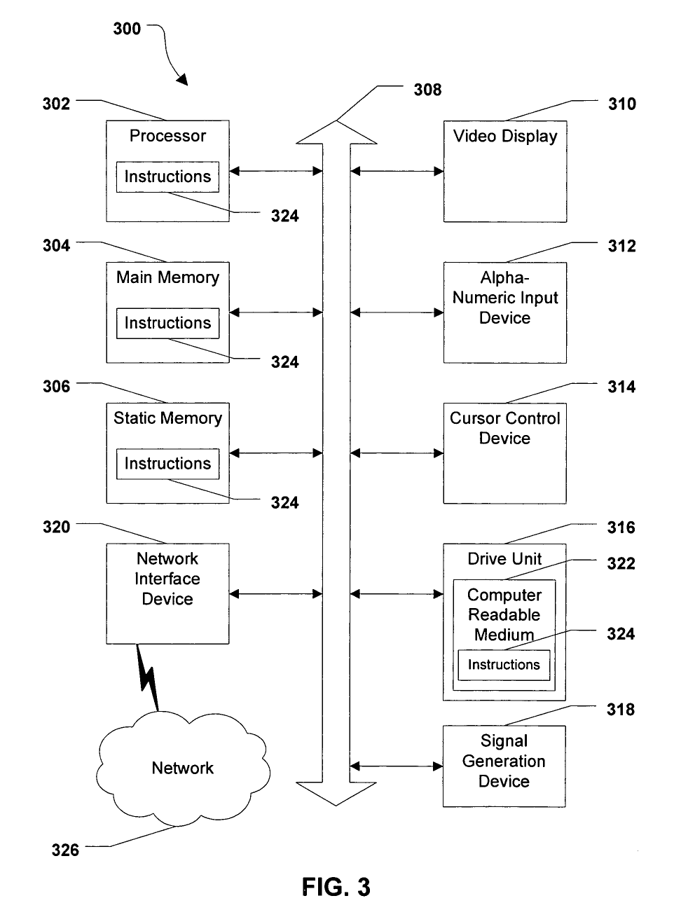

For example, referring to FIG. 3, an illustrative embodiment of a general computer system that may be used is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 3, the computer system 300 may include a processor 302, e.g., a central processing unit (CPU), a graphics processing unit (GPU), or both. Moreover, the computer system 300 can include a main memory 304 and a static memory 306, that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a wall-mounted touchpad. The computer system 300 can also include a disk drive unit 316, a signal generation device 318, such as a speaker or remote control, and a network interface device 320.

In a particular embodiment, as depicted in FIG. 3, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video, or data over the network 326. Further, the instructions 324 may be transmitted or received over the network 326 via the network interface device 320. Each of the components of the computer system 300 may be disposed within a protected enclosure to restrict user access.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
an inmate telephone for use by inmates of a prison or a mental institution, the inmate telephone absent an inmate-accessible hook-switch button, the inmate telephone comprising:
a device reader to detect a presence of a device issued to an inmate;
an activation circuit which, based on the device reader detecting the presence of the device, automatically places the inmate telephone in an off-hook state without automatically making an outgoing call in the off-hook state; and
a dialing interface usable by the inmate to dial a telephone number when the inmate telephone is in the off-hook state.

2. The system of claim 1, wherein the device reader detects an absence of the device, and wherein the activation circuit is responsive to the device reader detecting the absence of the device to place the inmate telephone in an on-hook state.

3. The system of claim 1, wherein the activation circuit places the inmate telephone in the off-hook state in response to both detecting the presence of the device and receiving a valid code entered using the dialing interface.

4. The system of claim 1, further comprising:
a tracking component which cooperates with the inmate telephone to track which of a plurality of prisoners have made calls to the telephone number, a frequency of the calls made to the telephone number, and times of the calls made to the telephone number.

5. The system of claim 1, wherein the device comprises a radio frequency identification tag, and wherein the device reader comprises a radio frequency identification tag reader.

6. The system of claim 1, wherein the device comprises an optical code, and wherein the device reader comprises an optical code reader.

7. The system of claim 6, wherein the optical code comprises a bar code and the optical code reader is a bar code reader.

8. The system of claim 1, wherein the dialing interface comprises a key pad.

9. The system of claim 1, wherein the inmate telephone is mounted to a wall of the prison or the mental institution.

10. A method comprising:
issuing a device to an inmate of a prison or a mental institution;
detecting a presence of the device in proximity to an inmate telephone, the inmate telephone being absent an inmate-accessible hook-switch button;
based on said detecting, placing the inmate telephone in an off-hook state without automatically making an outgoing call in the off-hook state;
receiving a telephone number dialed by the inmate using the inmate telephone when the inmate telephone is in the off-hook state; and
placing a call to the telephone number.

11. The method of claim 10, further comprising:
detecting an absence of the device; and
placing the inmate telephone in an on-hook state based on said detecting the absence of the device.

12. The method of claim 10, wherein the inmate telephone is placed in the off-hook state in response to both detecting the presence of the device and receiving a valid code entered using the dialing interface.

13. The method of claim 10, further comprising:
tracking which of a plurality of prisoners have made calls to the telephone number, a frequency of the calls made to the telephone number, and times of the calls made to the telephone number.

14. The method of claim 10, wherein the device comprises a radio frequency identification tag, and wherein said detecting the presence of the device is performed by a radio frequency identification tag reader.

15. The method of claim 10, wherein the device comprises an optical code, and wherein said detecting the presence of the device is performed by an optical code reader.

16. The method of claim 15, wherein the optical code comprises a bar code and the optical code reader is a bar code reader.

17. The method of claim 10, wherein the dialing interface comprises a key pad.

18. The method of claim 10, wherein the inmate telephone is mounted to a wall of the prison or the mental institution.

19. A system comprising:
an inmate telephone for use by inmates of a prison or a mental institution, the inmate telephone absent an inmate-accessible on-off button, the inmate telephone comprising:
a radio frequency identification (RFID) tag reader to detect a presence of an RFID tag issued to an inmate;
an activation circuit which, based on the RFID tag reader detecting the presence of the RFID tag automatically places the inmate telephone in an active state without automatically making an outgoing call in the active state; and
a dialing interface usable by the inmate to dial a telephone number when the inmate telephone is in the active state; and
wherein the RFID tag reader detects an absence of the RFID tag, and wherein the activation circuit is responsive to the RFID tag reader detecting the absence of the RFID tag to place the inmate telephone in an inactive state.

20. The system of claim 19, wherein the activation circuit is to place the inmate telephone in the active state in response to both detecting the presence of the RFID tag and receiving a valid code entered using the dialing interface.

21. The system of claim 19, wherein the inmate telephone is absent an inmate-accessible cord.
